(19) United States
(12) Patent Application Publication
(10) Pub. No.: US 2017/0121783 A1
(43) Pub. Date: May 4, 2017

(54) Cobalt-Lean alnico alloy

(71) Applicant: Iowa State University Research Foundation, Inc., Ames, IA (US)

(72) Inventors: Andriy Palasyuk, Ames, IA (US); Ralph W. McCallum, Santa Fe, NM (US); Iver E. Anderson, Ames, IA (US); Matthew Kramer, Ankeny, IA (US); Lin Zhou, Ames, IA (US); Wei Tang, Ames, IA (US)

(73) Assignee: Iowa State University Research Foundation, Inc.

(21) Appl. No.: 15/330,754

(22) Filed: Nov. 2, 2016

Related U.S. Application Data
(60) Provisional application No. 62/285,621, filed on Nov. 4, 2015.

(51) Int. Cl. C21D 6/00; C21D 1/04; H01F 1/03; C22C 30/02

(52) U.S. Cl. CPC C21D 6/007; C21D 6/001; C22C 30/02; C21D 1/04; H01F 1/0306

(57) ABSTRACT

Provided is an Alnico alloy that is lean (i.e., lower) in Co content and yet at least retains substantially the same or better magnetic properties as the corresponding more costly, commercially available Alnico grade alloy with higher Co content, such as grades 8 and 9, which include 31.5 atomic % or more Co, in order to save significant material costs.

### RELATED APPLICATION

This application claims benefit and priority of provisional application Ser. No. 62/285,621 filed Nov. 4, 2105, the entire disclosure of which is included herein by reference.

### CONTRACTUAL ORIGIN OF THE INVENTION

This invention was made with government support under Grant No. DE-AC02-07CH11358 awarded by the U.S. Department of Energy. The government has certain rights in the invention.

### FIELD OF THE INVENTION

The present invention relates to an Alnico alloy that is formulated to be leaner in Co content, Co being the most costly alloy component, but that retains at least substantially the same or better magnetic properties as the corresponding more costly, commercially available Alnico alloy with higher Co content.

### BACKGROUND OF THE INVENTION

Alnico alloys comprise as major alloying components Fe, Ni, Co and Al and are widely used in the production of magnets for many applications. Alnico magnets can exhibit anisotropic or isotropic magnetic properties as a result of different processing and chemistry.

Alnico alloys are widely available commercially in various grades that are made by different processing, such as powder metallurgy, sintering, and casting, and that have different alloy compositions. For example, the Table 1 below illustrates alloy compositions and magnetic properties of various Alnico magnets available commercially according to Standart Specifications for Permanent Magnet Materials (MMPA Standard 0100-00).

TABLE 1
COMMERCIAL ALNICO MAGNETS
(Ref: PERMANENT MAGNET MATERIALS (Ref: MMPA STANDARD 0100-00)

| IEC | | Co | Al | Ni | Cu | Ti | BH_{max.} | Bᵣ | H_{c} | H_{ci} |
|---|---|---|---|---|---|---|---|---|---|---|
| Code | Class | at. % | at. % | at. % | at. % | at. % | MGOe | Gauss | Oersted | Oersted |
| R1-0-2 | Cast Alnico 3 | 0 | 22.3 | 21.4 | 2.4 | 0 | 1.35 | 7000 | 480 | 500 |
| R1-1-1 | Cast Alnico 5 | 21.4 | 15.6 | 12.5 | 2.5 | 0 | 5.50 | 12800 | 640 | 640 |
| R1-1-2 | Cast Alnico 5DG | 21.4 | 15.6 | 12.5 | 2.5 | 0 | 6.50 | 13300 | 670 | 670 |
| R1-1-3 | Cast Alnico 5-7 | 21.4 | 15.6 | 12.5 | 2.5 | 0 | 7.50 | 13500 | 740 | 740 |
| R1-1-4 | Cast Alnico 6 | 21.4 | 15.6 | 14.3 | 2.5 | 1.1 | 3.90 | 10500 | 780 | 800 |
| R1-1-5 | Cast Alnico 8 | 31.5 | 13.8 | 13.6 | 3.3 | 5.5 | 5.30 | 8200 | 1650 | 1860 |
| R1-1-7 | Cast Alnico 8H | 33.7 | 15.5 | 12.5 | 2.5 | 8.7 | 5.00 | 7200 | 1900 | 2170 |
| R1-1-6 | Cast Alnico 9 | 31.5 | 13.8 | 13.6 | 3.3 | 5.5 | 9.00 | 10600 | 1500 | 1500 |
| R1-0-4 | Sintered Alnico 2 | 11.3 | 19.0 | 16.6 | 2.4 | 0 | 1.50 | 7100 | 550 | 570 |
| R1-1-10 | Sintered Alnico 5 | 21.4 | 15.6 | 12.5 | 2.5 | 0 | 3.90 | 10900 | 620 | 630 |
| R1-1-11 | Sintered Alnico 6 | 21.4 | 15.6 | 13.4 | 2.5 | 1.1 | 2.90 | 9400 | 790 | 820 |
| R1-1-12 | Sintered Alnico 8 | 31.5 | 13.8 | 13.6 | 3.3 | 5.5 | 4.00 | 7400 | 1500 | 1690 |
| R1-1-13 | Sintered Alnico 8H | 34.0 | 13.7 | 12.6 | 2.5 | 8.8 | 4.50 | 6700 | 1800 | 2020 |

Isotropic (unoriented) grades: Alnico 2, 3, 4
Anisotropic (oriented) grades: Alnico 5, 6, 8, 9

In the past, attempts have been made to reduce the Co content of Alnico alloys to save material costs. However, these attempts have achieved Co reduction within a narrow corridor of concentration with practically constant Ni contents wherein Co was equi-atomically substituted mainly by Fe, such prior attempts being described in JP 06069008, JP 48063919, JP 50026497, JP 49090210, and JP 52078708.

### SUMMARY OF THE INVENTION

The present invention provides an Alnico alloy that is leaner (i.e., lower in Co content) and yet retains at least substantially the same or better magnetic properties as the corresponding more costly, commercially available Alnico alloy with high Co content. The present invention is especially applicable to provide Co-lean Alnico alloys based on Alnico grades with high Co contents, such as grades 8 and 9 having about 31.5 atomic % or more Co, in order to save significant material costs. Additionally, significant savings in production costs can be achieved by optimization of the processing parameters (e.g., heat treatment times and temperatures) on the levels that require less energy in comparison to commercial Alnico grades.

In an illustrative embodiment of the present invention offered to illustrate but not limit the invention, a less costly Alnico magnet alloy is derived from the commercial Alnico grades 8 and 9 by practice of the present invention. In particular, a Co-lean grade is provided and comprises, in atomic %, about 15% to about 31% Co, about 14% to about 19% Al, about 14% to about 22% Ni, about 0.5% to about 4.0% Cu, about 6% to about 9% Ti, and about 29% to about 40% Fe. This alloy includes about 15 to 31 atomic % Co (as compared to at least 31.5% or more for the commercial alloys, see Table 1) and exhibits unexpected, dramatically better anisotropic magnetic characteristics at reduced costs after high temperature solutiunizing, oil or/and water quench, and low temperature magnetic anneals and multiple temperings (LT-draws where LT is low temperature), especially a final a low temperature treatment (LTT) at 490 to 500° C. for several days, such as for example 3 to 5 days.

Another illustrative embodiment of the present invention to this same end involves a less costly Co-lean Alnico magnet alloy comprising, in atomic %, about 10% to about 24% Co, about 14% to about 19% Al, about 18% to about 25% Ni, about 0.5% to about 4.0% Cu, about 6% to about 9% Ti, and about 29% to about 41% Fe.

In another illustrative embodiment of the present invention offered to illustrate but not limit the invention, a less costly Alnico magnet alloy is provided and comprises, in atomic %, about 15% to about 31% Co, about 14% to about 19% Al, about 14% to about 22% Ni, about 0.5% to about 4.0% Cu, about 6% to about 8.5% Ti, and about 32% to about 40% Fe. This alloy includes about 15 to 31 atomic % Co (as compared to at least 31.5% or more for the commercial alloys, see Table 1) and exhibits similar anisotropic magnetic characteristics at reduced costs after high temperature solutionizing, oil or/and water quench, and low temperature magnetic anneals and temperings (LT-draws where LT is low temperature).

Minor amounts of Nb, Si, Ge and S in quantities that are in the range of 0.2 to 1.0 atomic % may be present too. When Nb is present, the Nb content preferably is about 0.4% to about 0.8 atomic %.

From the above, it is apparent that the Co is being reduced significantly, while the Fe and Ni contents increase in respective nearly equal atomic proportions (e.g., see Table 1 for comparison).

Advantages and details of the present invention will become more readily understood from the following detailed description taken with the drawings.

### BRIEF DESCRIPTION OF THE DRAWINGS

FIG. 1 shows magnetic B-H hysteresis loops (indicating coercive forces H_{ci} and residual inductions Bᵣ) of both an Alnico grade 8_{AMES} Fe_{37.7}Co_{19.6}Ni_{18.9}Al_{14.3}Ti₇Cu_{2.5} alloy pursuant to the invention, although not optimized for magnetic properties, and a commercial cast Alnico grade 8H in its optimized condition.

FIG. 2 shows XRD (X-ray diffraction data) for the grade 8_{AMES} Fe_{37.7}Co_{19.6}Ni_{18.9}Al_{14.3}Ti₇Cu_{2.5} alloy pursuant to the invention in the as-cast condition and in heat treated conditions.

FIG. 3 illustrates the optimization of magnetic annealing time for cast grade 8_{AMES} Fe_{37.7}Co_{19.6}Ni_{18.9}Al_{14.3}Ti₇Cu_{2.5} pursuant to the invention.

FIG. 4 illustrates the optimization of magnetic annealing temperature for the cast grade 8_{AMES} Fe_{37.7}Co_{19.6}Ni_{18.9}Al_{14.3}Ti₇Cu_{2.5} pursuant to the invention.

FIG. 5 illustrates the effect of LT-draws (550 degrees C. for 12 hours) on magnetic B-H loops (demagnetization curves) for the cast grade 8_{AMES} Fe_{37.7}Co_{19.6}Ni_{18.9}Al_{14.3}Ti₇Cu_{2.5} alloy pursuant to the invention.

FIG. 6 shows the effect of magnetic annealing (MA) (825 degrees C. for 7 minutes) and the effect of subsequent LT-draw (550 degrees C. for 12 hours) on lattice parameters of the spinodal phases of the nanostructure of the grade 8_{AMES} alloy pursuant to the invention. The alloy was initially solutionized at 1170 degrees for 20 minutes.

FIGS. 7A and 7B are SEM images of the nanostructure of the cast grade 8_{AMES} Fe_{37.7}Co_{19.6}Ni_{18.9}Al_{14.3}Ti₇Cu_{2.5} alloy pursuant to the invention after LT-draw wherein FIG. 7B is a higher magnification image.

FIGS. 8 and 9 chow optimization of the magnetic properties (H_{ci}) of the anisotropic cast grade 8_{AMES} alloy pursuant to the invention by lower temperature solutionizing heat treatment at 1170 degrees C. for 20 minutes with subsequent oil quenching followed by magnetic annealing at 837-843 degrees C. for 8-10 minutes.

FIG. 10 illustrates that still further optimization of magnetic properties Bᵣ and H_{ci} can be achieved by subjecting the magnetically annealed specimens to a LT-draw (tempering) at 680 then at 580 degrees C. for 1 and 12 hours, respectively. Commercial Arnold Alnico 8 magnetic properties are shown for comparison purposes.

FIG. 11 shows the effect of magnetic annealing (MA) (840 degrees C. for 8 minutes) and the effect of subsequent LT-draw (680 then at 580 degrees C. for 1 and 12 hours, respectively) on lattice parameters of the spinodal phases of the nanostructure of the grade 8_{AMES} alloy pursuant to the invention. The alloy was initially solutionized at 1170 degrees for 20 minutes.

FIGS. 12A, 12B show the refined spinodal nanostructure comprised of regular array of coherent α1(B2′)/α2(L2₁) phase components of a size of about 50 nanometers obtained from the processing used for FIG. 10. FIG. 12B is a higher magnification of the bounded area of FIG. 12A. A grain boundary phase width (grain boundary phase is a γ-phase) of about 100-170 μm and a SD-size of 40-50 nm, where SD-size is the average distance between the centers of magnetic rods, i.e., α1(B2′)-phase, are indicated.

FIG. 13A illustrates the effect of the heat treatments of FIG. 13B on magnetic B-H loops (demagnetization curves) for cast and heat treated Fe_{32.5}Co_{28.0}Ni_{15.5}Al_{15.0}Ti_{7.5}Nb_{0.5}Cu_{1.0} alloy (designated Alnico 8_{Ames-2000}) pursuant to another embodiment of the invention described in Example 3.

FIG. 13B illustrates a heat treatment sequence for Example 3 involving a first magnetic annealing (designated MA), a second lower temperature Full Heat Treatment (designated FHT), and a third Low Temperature Treatment (designated FHT-LTT)).

FIG. 14A illustrates the effect of heat treatments of FIG. 14B on magnetic B-H loops for cast and heat treated Fe_{32.0}Co_{28.0}Ni_{15.0}Al_{15.0}Ti_{7.5}N_{0.5}Cu_{2.0} alloy (designated Alnico 8_{Ames-2100} pursuant to another embodiment of the invention described in Example 4.

FIG. 14B illustrates a heat treatment sequence for Example 4 involving a first magnetic annealing (designated MA), a second lower temperature Full Heat Treatment (designated FHT), and a third Low Temperature Treatment (designated FHT-LTT)).

FIG. 15A illustrates the effect of heat treatments of FIG. 15B on magnetic B-H loops for cast and heat treated Fe_{29.1}Co_{29.0}Ni_{14.7}Al_{15.4}Ti_{8.7}Nb_{0.6}Cu_{2.5} alloy (designated Alnico 8_{Ames-2500}) pursuant to another embodiment of the invention described in Example 5.

FIG. 15B illustrates a heat treatment sequence for Example 5 involving a first magnetic annealing (designated MA), a second lower temperature Full Heat Treatment (designated FHT), and a third Low Temperature Treatment (designated FHT-LTT)).

FIG. 15C is a transmission electron microscope (TEM) image (scale bar 50 μm) illustrating the sample microstructure of Example 5 after the magnetic annealing (MA) treatment comprised of the spinodal nanostructure comprised of regular array of coherent α1(B2′)/α2(L2₁) phase components. A table is included in the figure illustrating phase compositions at the two areas within the boxes of the TEM image where the top lines of the table correspond to the lower box.

FIG. 15D is a transmission electron microscope image (scale bar 50 μm) illustrating the sample microstructure of Example 5 after the full heat treatment comprised of refined spinodal nanostructure comprised of regular array of coherent α1(B2′)/α2(L2₁) phase components of a size of about 50 nanometers. A table is included in the figure illustrating phase compositions at the two areas within the boxes of the TEM image where the top lines of the table correspond to the upper box.

FIG. 16A illustrates the effect of heat treatments of FIG. 16B on magnetic B-H loops for cast and heat heated Fe_{29.9}Co_{29.2}Ni_{14.6}Al_{14.6}Ti_{8.6}Nb_{0.5}Cu_{2.6} alloy (designated Alnico 8_{Ames-2500}) pursuant to another embodiment of the invention described in Example 5a.

FIG. 16B illustrates a heat treatment sequence for Example 5a involving a first magnetic annealing (designated MA), a second lower temperature Full Heat Treatment (designated FHT), and a third Low Temperature Treatment (designated FHT-LTT)).

### DESCRIPTION OF THE INVENTION

Practice of the present invention involves the equi-electronic substitution of the Co content by Fe and Ni in various Co-rich Alnico alloys without disruption of the self-assembled spinodal nanostructure of the magnet, which spinodal nanostructure is an essential component of the coercivity mechanism of Alnico magnets. This becomes possible by the application of the Rigid Band Approximation approach that assumes that structure of electron bands of the alloy remain not distorted (i.e., rigid) even after certain chemical modifications, especially if the applied chemical adjustments do not significantly change the total electron concentration of that alloy, i.e. e/a=constant., according to the present invention can be practiced to provide novel Co-lean Alnico alloys based on Alnico grades having relatively higher Co contents such as Alnico grades 8 and 9 having 31.5 atomic % or more Co. Practice of the present invention provides such novel Co-lean Alnico alloys at significant material costs savings without sacrificing magnetic properties as compared to the commercial Co-rich counterpart alloy. For example, practice of the present invention can reduce the total Co content of Co-rich Alnico alloys by up to 40% or more, such as typically by at least about 14-15%. The omitted Co preferably is replaced with respective equal atomic proportions of cheaper Fe and Ni.

Pursuant to an illustrative embodiment of the invention, a Co-lean Alnico alloy based on Alnico grades 8 and 9 can have a composition, in atomic %, of about 15% to 31% Co, about 14% to about 19% Al, about 14% to about 22% Ni, about 0.5% to about 4.0% Cu, about 6% to about 9% Ti, and about 29% to about 40% Fe. Minor amounts of Nb, Si, Ge and S in quantities in the range of 0.2 to 1.0 atomic % may be present too. When Nb is present, Nb preferably is 0.4 to about 0.8 atomic %.

The Co content preferably does not exceed 30 atomic % of the alloy. The Co is reduced, while the Fe and Ni contents are increased in respective equal atomic proportions (e.g., see Table 1 for comparison). When subjected to a solution treatment followed by magnetic annealing and then multiple low temperature treatments that include a relatively lower final temperature treatment at 490 to 500° C. for several days, such as 3-5 days, this alloy unexpectedly far surpasses the standard Alnico grades 8 and 9 in terms of intrinsic coercive force H_{ci} and energy product (BH)ₘₐₓ. For example, such a heat treated alloy exhibits a coercive force of at least about 2000 Oe, such as about 2400 to about 2500 Oe.

An illustrative heat treatment to this end comprises a solution treatment at about 1160 to about 1170° C. for time such as about 10 to about 30 minutes; for example about 20 min. The solution treatment is followed by magnetic annealing conducted at about 840 to about 860° C. for about 7 to about 10 minutes. The magnetic annealing is followed by multiple low temperature treatments that include the following:

a first low temperature treatment conducted at about 640 to about 660 for about 1.5 to 2.5 hours, then
a second low temperature treatment at about 570 to about 590 for about 14 to 16 hours, and
a final low temperature treatment at about 490 to about 500 for about 3 to 5 days.

For example, such a heat treated alloy exhibits a coercive force of at least about 2000 Oe and preferably at least about 2400 Oe, such as about 2400 to about 2500 Oe.

Another illustrative embodiment of the present invention to this same end involves a less costly Co-lean Alnico magnet alloy comprising, in atomic %, about 10% to about 24% Co, about 14% to about 19% Al, about 18% to about 25% Ni, about 0.5% to about 4.0% Cu, about 6% to about 9% Ti, and about 29% to about 41% Fe. It is apparent that the Co is being reduced significantly, while the Fe and Ni contents increase in respective equal atomic proportions.

Another illustrative embodiment of a Co-lean Alnico alloy can have a composition, in atomic %, of about 15% to 31% Co, about 14% to about 19% Al, about 14% to about 22% Ni, about 0.5% to about 4.0% Cu, about 6% to about 8.5% Ti, and about 32% to about 40% Fe. Minor amounts of Nb, Si, Ge and S in quantities in the range of 0.2 to 1.0 atomic % may be present too. The Co content preferably does not exceed 30 atomic % of the alloy. The Co is reduced, while the Fe and Ni contents are increased in respective equal atomic proportions (e.g., see Table 1 for comparison).

### Example 1

The following Example 1 is offered to further illustrate an embodiment of the present invention wherein a less costly Alnico magnet is derived from one of compositional variants of commercial cast Alnico grade 8H, i.e., alloy Fe_{30.5}Co₃₄Ni_{11.7}Al_{14.3}Ti₇Cu_{2.5}, by practice of the present invention. In particular, greater than about 40% of total Co content, particularly about 42%, is equi-electronically substituted by Fe and Ni in respective equal amounts to yield a grade 8_{AMES} alloy comprising Fe_{37.7}Co_{19.6}Ni_{18.9}Al_{14.3}Ti₇Cu_{2.5}. Importantly, the resulting Co-lean alloy maintains similar magnetic characteristics at significantly reduced costs after a solutionizing at 1250 degrees C. for 20 minutes followed by oil quench and magnetic anneals at lower temperature as will become apparent below.

In this Example 1, both the commercial grade 8H (Fe_{30.5}Co₃₄Ni_{11.7}Al_{14.3}Ti₇Cu_{2.5}) alloy and the grade 8_{AMES} (Fe_{37.7}Co_{19.6}Ni_{18.9}Al_{14.3}Ti₇Cu_{2.5}) alloy pursuant to the invention were arc-melted and cast into cylindrical specimens. The commercial grade 8H alloy and the cast grade 8_{AMES} alloy pursuant to the invention were each cooled to room temperature radiantly. Then, out of both commercial and the novel alloys, small cylinders with outer diameter of about 3 millimeters length of about 8 millimeters were cut ready for tests.

Each specimen of the commercial cast grade 8H alloy was subjected to a solutionizing heat treatment at 1250 degrees C. for 20 minutes and then oil quenched. The specimens then were annealed at 840 degrees C. for 10 minutes and went through LT-draws at 650° C. then at 580° C. for 5 and 15 hours, respectively, to optimize magnetic properties.

Specimens of cast grade 8_{AMES} alloy pursuant to the invention were subjected to a solutionizing heat treatment at 1250 degrees C. for 20 minutes and oil quenched. Similar to the commercial grade 8H alloy, the crystallographically anisotropic novel grade 8_{AMES} alloy pursuant to the invention clearly showed predominant formation of high temperature α-phase (B2) that transformed during spinodal reaction into fine and uniform trace of crystallographically coherent α1(B2′)/α2(L2₁) phase components as determined by SEM (scanning electron microscope) and XRD (X-ray diffraction) analyses.

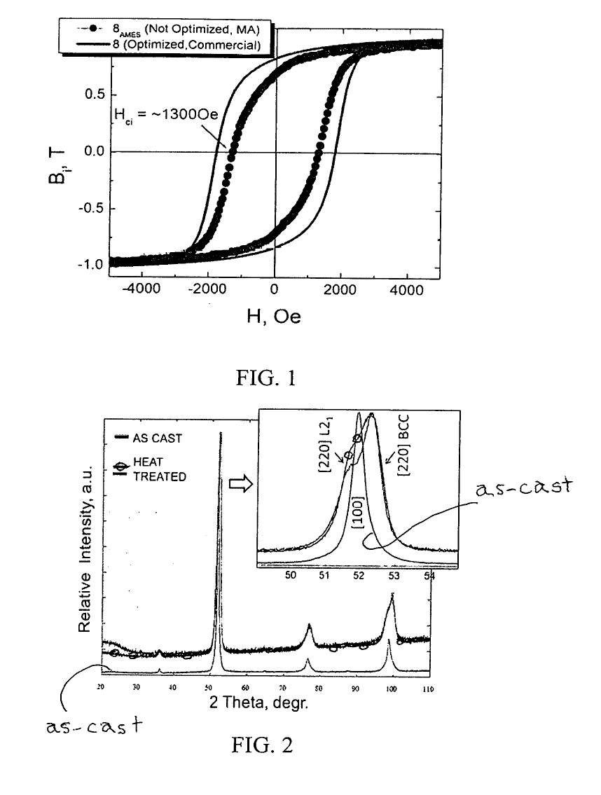

A series of specimens of cast grade 8_{AMES} alloy pursuant to the invention were subjected to a series of preliminary lower temperature magnetic anneals at 840-850 degrees C. for 10-20 minutes. Even at these not optimal heat treatments the anisotropic grade 8_{AMES} alloy pursuant to the invention exhibited magnetic properties comparable to the commercial grade 8H; namely intrinsic coercive force H_{ci}=1300 Oe and residual induction Bᵣ=0.62 T, see FIGS. 1 and 2.

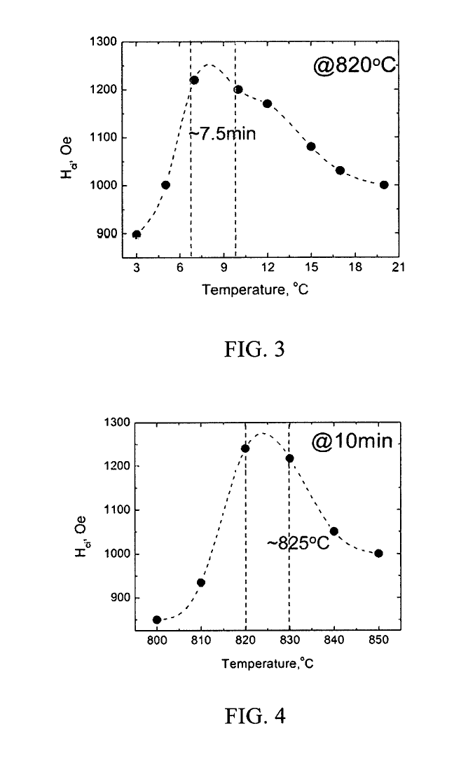

The optimization of the magnetic properties of the anisotropic cast grade 8_{AMES} alloy pursuant to the invention was achieved by lower temperature solutionizing heat treatment at 1170 degrees C. for 20 minutes with subsequent oil quenching followed by magnetic annealing at 820-830 degrees C. for 7-9 minutes, see FIGS. 3 and 4.

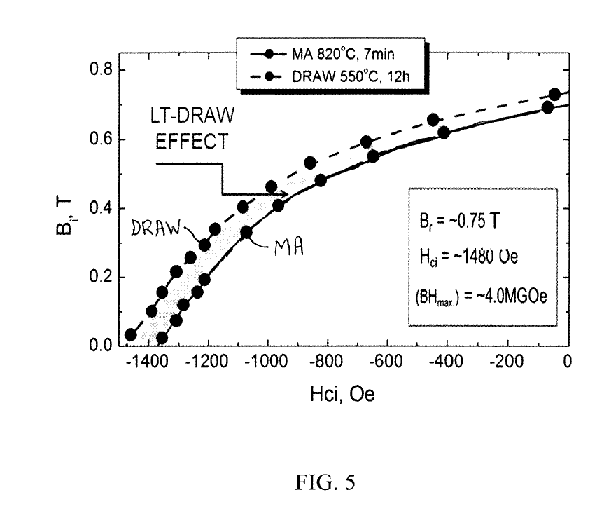

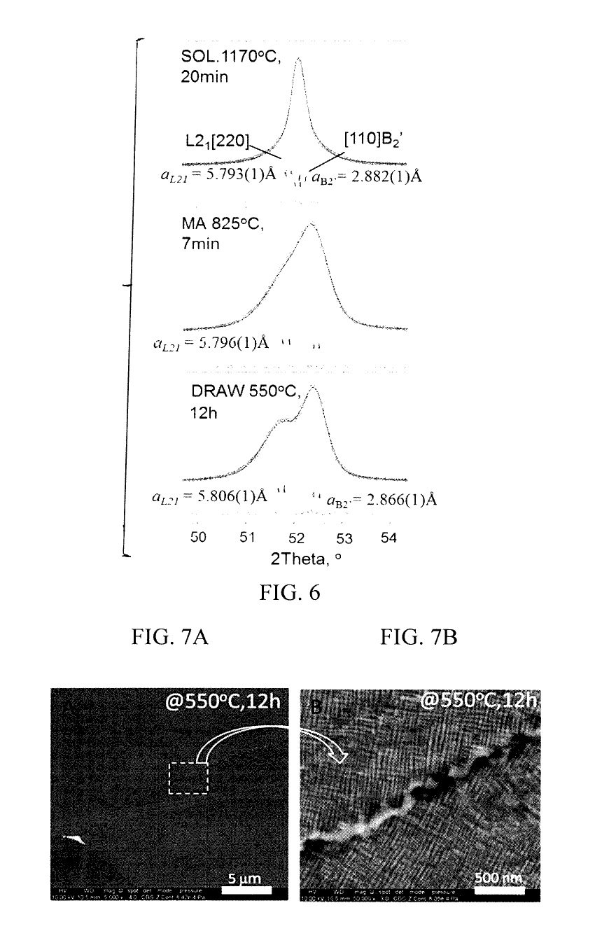

Still further optimization can be achieved by subjecting the magnetically annealed specimens to a LT-draw (tempering) heat treatment at 550 degrees C. for 12 hours. The drawing (tempering) effect on the magnetic annealed specimens produced an increase in magnetic properties; H_{ci}; =1480 Oe, Bᵣ=0.75 T and energy product (BH)ₘₐₓ=4.0 MGOe; FIG. 5, and refined spinodal nanostructure comprising of regular array of coherent α1(B2′)/α2(L2₁) phase components of a size of about 65 nanometers, FIGS. 6 and 7A, 7B.

### Example 2

The next Example 2 is provided to further emphasize an embodiment of the present invention wherein a less costly Alnico magnet is derived from the composition of commercial sintered Alnico grade 8H (see Table 1), i.e., alloy Fe_{28.4}Co₃₄Ni_{12.6}Al_{13.7}Ti_{8.8}Cu_{2.5}, by practice of the present invention. In particular, greater than about 35% of total Co content, particularly about 37%, is equi-electronically substituted by Fe and Ni in respective equal amounts to yield a novel grade 8_{AMES} comprising Fe_{35.0}Co_{21.5}Ni_{19.0}Al_{15.0}Ti_{7.5}Nb_{0.5}Cu_{1.5}. Minor Nb additive of about 0.5 atomic % and concentration adjustments of Al, Ti and Cu resulting Co-lean alloy are within the defined tolerance corridors of the present invention. Importantly, this Co-lean alloy maintains the same magnetic characteristics at significantly reduced costs after a solutionizing at 1170 degrees C. for 20 minutes followed by oil quench, magnetic anneals and LT-draws at lower temperatures as will become apparent below.

In this Example 2, the grade 8_{AMES} (Fe_{35.0}Co_{21.5}Ni_{19.0}Al_{15.0}Ti_{7.5}Nb_{0.5}Cu_{2.5}) pursuant to the invention was arc-melted and drop-cast. The cast grade 8_{AMES} alloy pursuant to the invention was cooled to room temperature radiantly. Then, the small cylinders with outer diameter of about 3 millimeters and length of about 8 millimeters were cut ready for tests.

Similar to the commercial grade 8H alloy, the crystallographically anisotropic grade 8_{AMES} alloy pursuant to the invention clearly showed predominant formation of high temperature α-phase (B2) that transformed during spinodal reaction into fine and uniform trace of crystallographically coherent α1(B2′)/α2(L2₁) phase components as determined by SEM (scanning electron microscope) and XRD (X-ray diffraction) analyses.

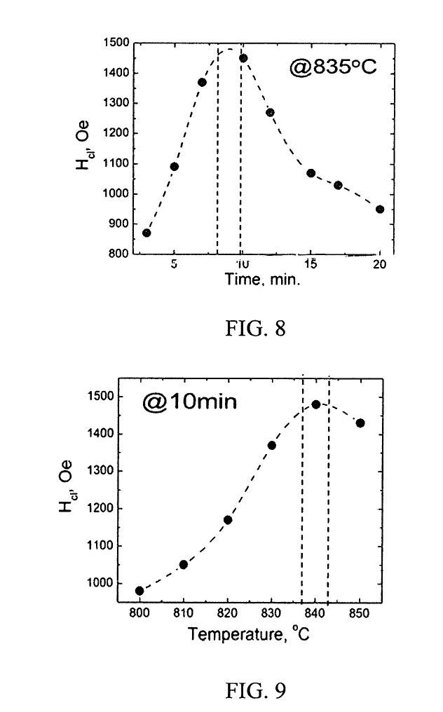

The optimization of the magnetic properties of the anisotropic cast grade 8_{AMES} alloy pursuant to the invention was achieved by lower temperature solutionizing heat treatment at 1170 degrees C. for 20 minutes with subsequent oil quenching followed by magnetic annealing at 837-843 degrees C. for 8-10 minutes, see FIGS. 8 and 9.

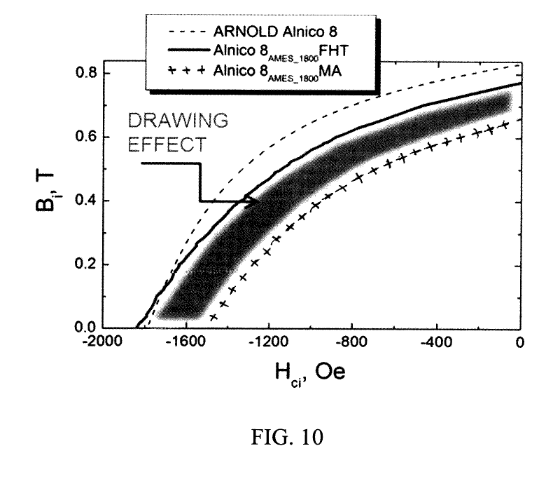

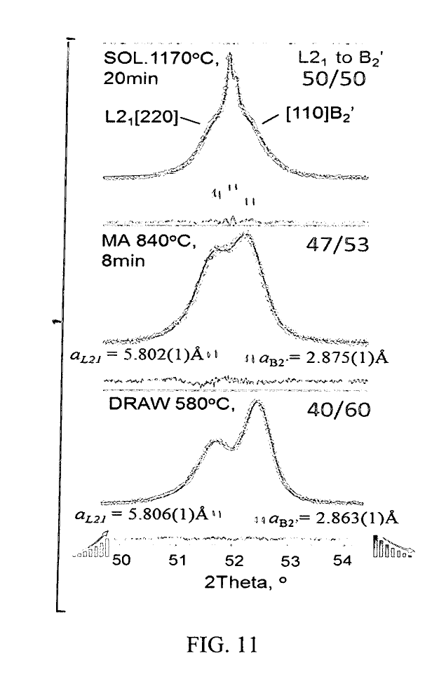

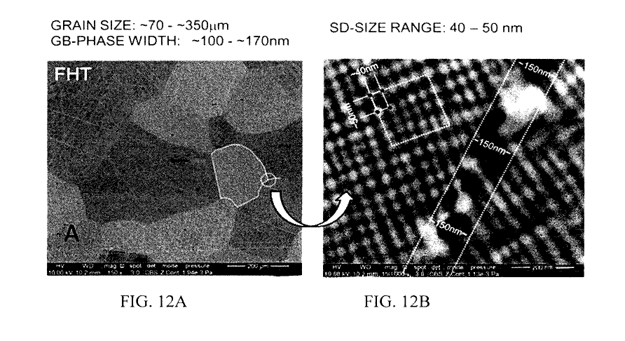

Still further optimization can be achieved by subjecting the magnetically annealed specimens to a LT-draw (tempering) heat treatments at 680 then at 580 degrees C. for 1 and 12 hours, respectively. The drawing (tempering) effect on the magnetic annealed specimens produced an increase in magnetic properties; H_{ci}=1850 Oe, Bᵣ=0.78 T and energy product (BH)ₘₐₓ=4.7 MGOe; FIG. 10, and refined spinodal nanostructure comprising of regular array of coherent α1(B2′)/α2(L2₁) phase components of a size of about 50 nanometers, FIGS. 11 and 12A, 7B.

### Example 3

The next Example 3 is provided to further illustrate a particular embodiment of the present invention wherein a less costly Alnico magnet is provided and comprises a cast and heat treated Alnico grade 8_{AMES-2000} Fe_{32.5}Co_{28.0}Ni_{15.5}Al_{15.0}Ti_{7.5}Nb_{0.5}Cu_{1.0} alloy. This alloy has about 18% less Co as compared to commercial sintered ARNOLD grade 8H Alnico alloy.

In this Example 3, the Fe_{32.5}Co_{28.0}Ni_{15.5}Al_{15.0}Ti_{7.5}Nb_{0.5}Cu_{1.0} alloy pursuant to the invention was arc-melted and cast in a shaped cavity of a water-cooled copper hearth, where the specimen was cooled radially to room temperature. Then, the small cylinders with outer diameter of about 3 millimeters length of about 8 millimeters were cut ready for tests.

The optimization of the magnetic properties of the anisotropic cast alloy pursuant to the invention was achieved by lower temperature solutionizing heat treatment at 1165 degrees C. for 20 minutes with subsequent ice-water quenching. Similar to the commercial sintered ARNOLD grade 8H Alnico alloy, the crystallographically anisotropic alloy pursuant to the invention clearly showed predominant formation of high temperature α-phase (B2) that transformed during spinodal reaction into fine and uniform trace of crystallographically coherent α1(B2′)/α2(L2₁) phase components as determined by SEM (scanning electron microscope) and XRD (X-ray diffraction) analyses.

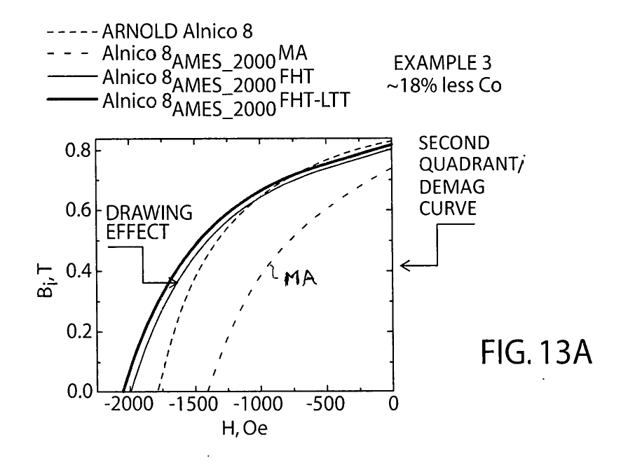

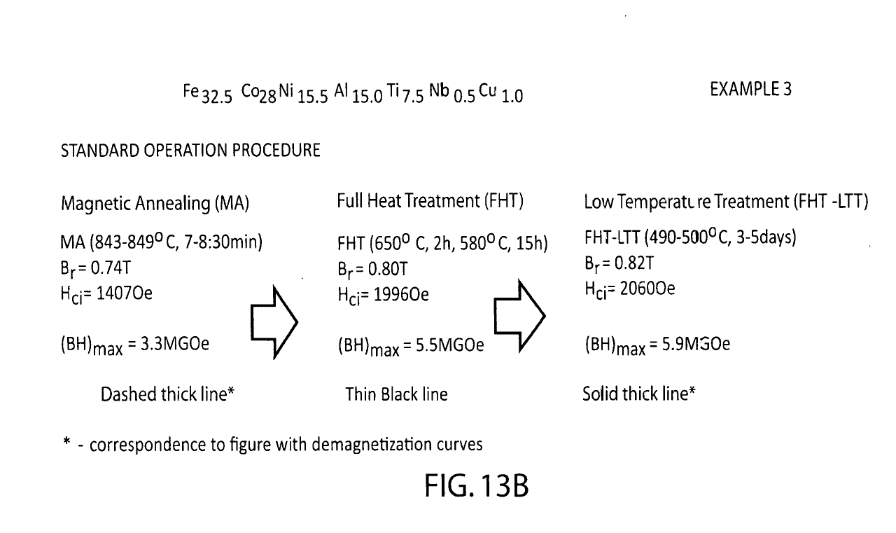

The alloy specimens then were subjected to the heat treatments shown in FIG. 13B. FIG. 13A illustrates the effect of heat treatments of FIG. 13B on the second quadrant/demagnetization curves (from the B-H loops) of the water quenched alloy specimens pursuant to the invention described.

FIG. 13A reveals that the MA-treated alloy sample (dashed black line labeled MA) exhibited a (BH)ₘₐₓ=3.3 MGOe; that the FHT-treated alloy sample (thin solid black line) exhibited an energy product (BH)ₘₐₓ=5.5 MGOe; and that the FHT-LTT alloy sample (thick solid black line) exhibited a (BH)ₘₐₓ=5.9 MGOe.

FIG. 13A also reveals that the MA-treated alloy sample exhibited an intrinsic coercive force H_{ci.}=1407 Oe; that the FHT-treated alloy sample exhibited an H_{ci.}=1996 Oe; and that the FHT-LTT alloy sample exhibited an H_{ci.}=2060 Oe.

FIG. 13A further shows that the Example 3 alloy reaches a magnetic remanence Bᵣ of 0.74-0.82 T, which are practically identical to the same values of ARNOLD Alnico 8 grade (closely spaced dashed line), while the coercivity values are equal or better to sintered commercial Alnico 8H grade (Table 1).

Scanning electron microscopy evaluation of the microstructure of the specimens subjected to the MA, FHT, and FHT-LTT heat treatment exhibited a grain size of about 100-500 μm; a grain boundary phase width (grain boundary phase is a γ-phase) of about 100-150 μm; and a SD-size of 40-50 nm where SD-size is the average distance between the centers of magnetic rods, i.e., α1(B2′)-phase.

### Example 4

The next Example 4 is provided to further illustrate a particular embodiment of the present invention wherein a less costly Alnico magnet is provided and comprises a cast and heat treated Alnico grade 8_{AMES-2100} Fe_{32.0}Co_{28.0}Ni_{15.0}Al_{15.0}Ti_{7.5}Nb_{0.5}Cu_{2.0} alloy. This alloy also has about 18% less Co as compared to commercial sintered ARNOLD grade 8H Alnico alloy.

In this Example 4, the Fe_{35.0}Co_{21.5}Ni_{19.0}Al_{15.0}Ti_{7.5}Nb_{0.5}Cu_{2.5} alloy pursuant to the invention was arc-melted and cast in a shaped cavity of a water-cooled copper hearth, where the specimen was cooled radially to room temperature. Then, the small cylinders with outer diameter of about 3 millimeters length of about 8 millimeters were cut ready for tests.

The optimization of the magnetic properties of the anisotropic cast alloy pursuant to the invention was achieved by lower temperature solutionizing heat treatment at 1165 degrees C. for 20 minutes with subsequent ice-water quenching. Similar to the commercial sintered ARNOLD grade 8H Alnico alloy, the crystallographically anisotropic alloy pursuant to the invention clearly showed predominant formation of high temperature α-phase (B2) that transformed during spinodal reaction into fine and uniform trace of crystallographically coherent α1(B2′)/α2(L2₁) phase components as determined by SEM (scanning electron microscope) and XRD (X-ray diffraction) analyses.

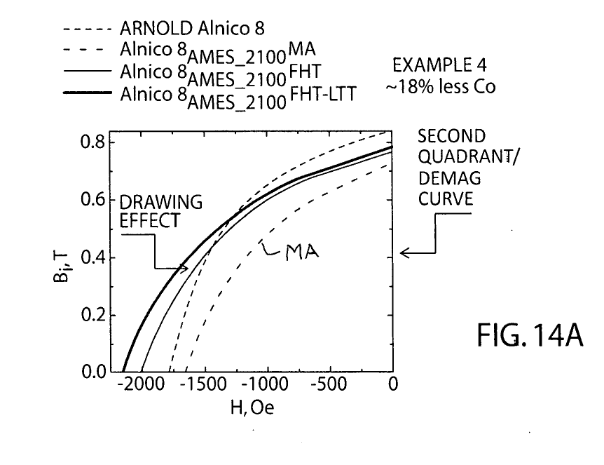

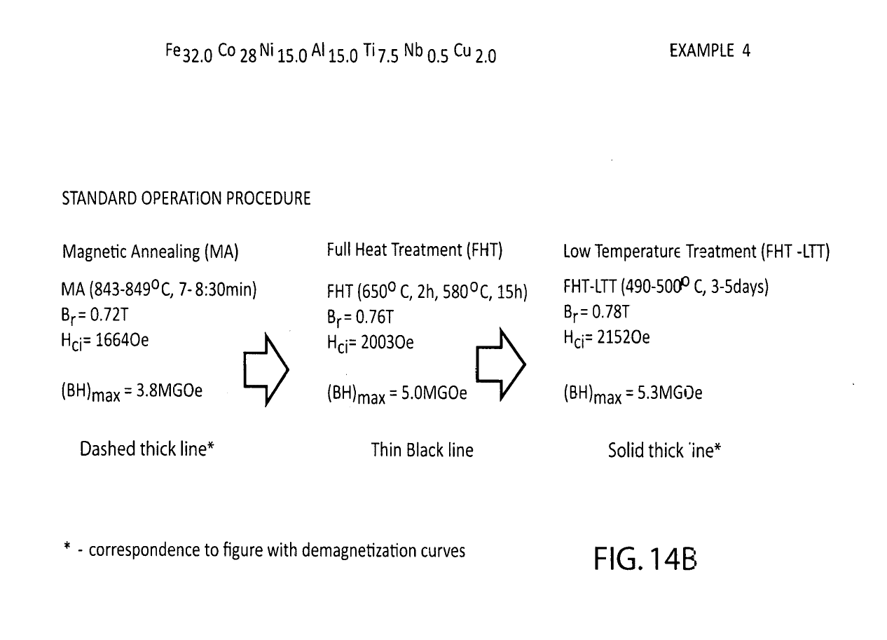

The alloy specimens then were subjected to the heat treatments shown in FIG. 14B. FIG. 14A illustrates the effect of the heat treatments of FIG. 14B on the second quadrant/demagnetization curves (from the B-H loops) of the water quenched alloy pursuant to the invention described.

FIG. 14A reveals that the MA-treated alloy sample (dashed line labelled MA) exhibited a (BH)ₘₐₓ=3.8 MGOe; that the FHT-treated alloy sample (thin solid black line) exhibited an energy product (BH)ₘₐₓ=5.0 MGOe; and that the FHT-LTT alloy sample (thick solid black line) exhibited a (BH)ₘₐₓ=5.3 MGOe.

FIG. 14A also reveals that the MA-treated alloy sample exhibited an intrinsic coercive force H_{ci.}=1664 Oe; that the FHT-treated alloy sample exhibited an H_{ci.}=2003 Oe; and that the FHT-LTT alloy sample exhibited an H_{ci.}=2152 Oe.

FIG. 14A further shows that the Example 4 alloy reaches a magnetic remanence Bᵣ of 0.72-0.78 T, which are comparable with values of ARNOLD Alnico 8 grade (closely spaced dashed line), while the coercivity values are equal or better to cast commercial Alnico 8H grade (Table 1). Scanning electron micrsocopy evaluation of the microstructure of the specimens subjected to the MA, FHT, and FHT-LTT heat treatment exhibited a grain size of about 100-300 μm; a grain boundary phase width (grain boundary phase is γ-phase) of about 100-150 μm; and a SD-size of 30-50 nm.

### Example 5

The next Example 5 is provided to further illustrate a particular embodiment of the present invention wherein a less costly Alnico magnet is provided and comprises a cast and heat treated Alnico grade 8_{AMES-2500} Fe_{29.1}Co_{29.0}Ni_{14.7}Al_{15.4}Ti_{8.7}Nb_{0.6}Cu_{2.5} alloy. This alloy also has about 15% less Co as compared to commercial sintered ARNOLD grade 8H Alnico alloy.

In this Example 5, the Fe_{29.1}Co_{29.0}Ni_{14.7}Al_{15.4}Ti_{8.7}Nb_{0.6}Cu_{2.5} alloy pursuant to the invention was arc-melted and cast in a shaped cavity of a water-cooled copper hearth, where the specimen was cooled radially to room temperature. Then, the small cylinders with outer diameter of about 3 millimeters length of about 8 millimeters were cut ready for tests.

The optimization of the magnetic properties of the anisotropic cast alloy pursuant to the invention was achieved by lower temperature solutionizing heat treatment at 1165 degrees C. for 20 minutes with subsequent ice-water quenching. Similar to the commercial sintered ARNOLD grade 8H Alnico alloy, the crystallographically anisotropic alloy pursuant to the invention clearly showed predominant formation of high temperature α-phase (B2) that transformed during spinodal reaction into fine and uniform trace of crystallographically coherent α1(B2′)/α2(L2₁) phase components as determined by SEM (scanning electron microscope) and XRD (X-ray diffraction) analyses.

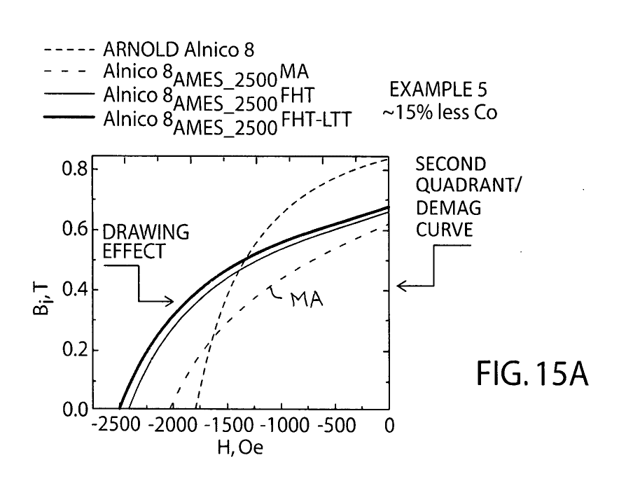

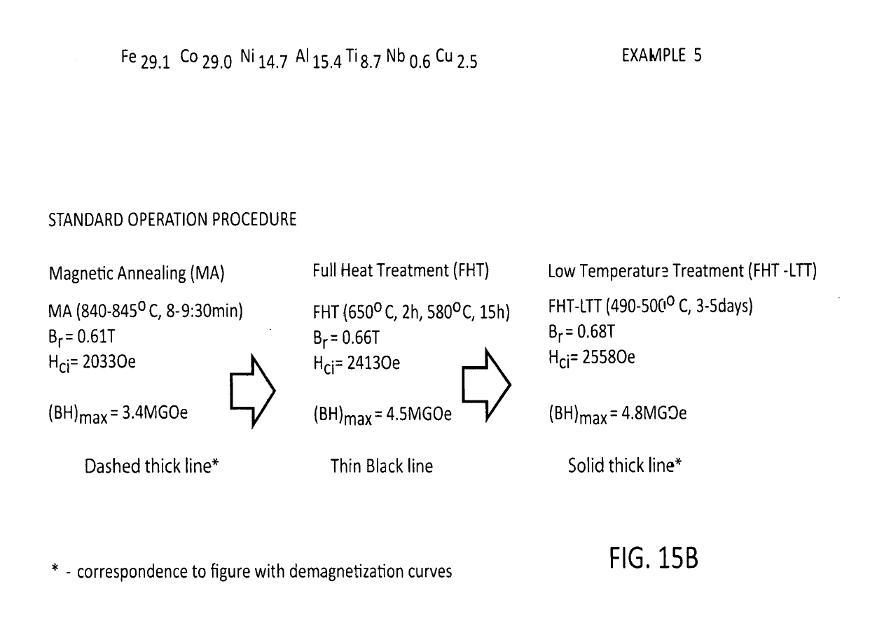

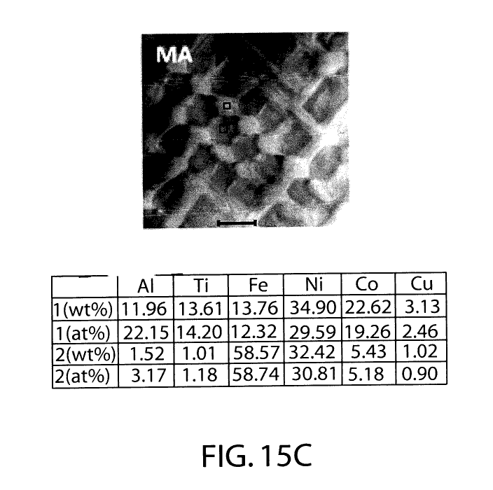

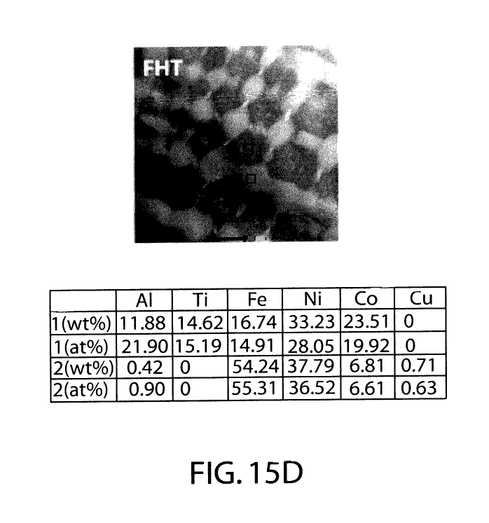

The alloy specimens then were subjected to the heat treatments shown in FIG. 15B. FIG. 15A illustrates the effect of the heat treatments of FIG. 15B on the second quadrant/demagnetization curves (from the B-H loops) of the water quenched alloy pursuant to the invention described.

FIG. 15A illustrates the effect of the heat treatments of FIG. 15B on the second quadrant/demagnetization curves (from the B-H loops) for the heat treated alloy pursuant to the invention described.

FIG. 15A reveals that the MA-treated alloy sample (dashed black line labelled MA) exhibited a (BH)ₘₐₓ=3.4 MGOe; that the FHT-treated alloy sample (thin solid black line) exhibited an energy product (BH)ₘₐₓ=4.50 MGOe; and that the FHT-LTT alloy sample (thick solid black line) exhibited a (BH)ₘₐₓ=4.8 MGOe.

FIG. 15A also reveals that the MA-treated alloy sample exhibited an intrinsic coercive force H_{ci.}=2033 Oe; that the FHT-treated alloy sample exhibited an H_{ci.}=2413 Oe; and that the FHT-LTT alloy sample exhibited an H_{ci.}=2558 Oe.

Referring to FIG. 15C, a transmission electron microscope (TEM) image (scale bar 50 μm) illustrates the sample microstructure of Example 5 after the magnetic annealing (MA) treatment comprised of the spinodal nanostructure comprised of regular array of coherent α1(B2′)/α2(L2₁) phase components where the lighter phase is α1 and the darker phase is α2. A table is included in FIG. 15C showing the different phase compositions (at the two areas within the boxes of the TEM image). The volume fraction of the L2₁ phase and the B2′ phase in the MA-treated microstructure were determined by XRD to be 56% and 44%, respectively. Such high volume fraction the L2₁ phase is beneficial for magnetic properties; in particular, it significantly improves coercivity as compared to Examples 1 and 2, in which volume fractions of L2₁ were less than 50%.

Referring to FIG. 15D, a transmission electron microscope image (scale bar 50 μm) illustrates the sample microstructure of Example 5 after the full heat treatment comprised of refined spinodal nanostructure comprised of regular array of coherent α1(B2′)/α2(L2) phase components of a size of about 50 nanometers where the lighter phase is al, and the darker phase is α2. The table included in FIG. 15D illustrates the different phase compositions (at the two areas within the boxes of the TEM image).

The volume fraction of L2₁ phase and the B2′ phase in the FHT-LTT-treated microstructure were determined by XRD to be 51% and 49%, respectively. The increase in volume fraction the B2′ phase is beneficial for magnetic properties; in particular, it improves the final values of magnetic remanence.

### Example 5a

The next Example 5a is provided to further illustrate a particular preferred embodiment of the present invention wherein a less costly Alnico magnet is provided and comprises a cast and heated Alnico grade 8_{AMES-2500} Fc_{29.9}Co_{29.2}Ni_{14.6}Al_{14.6}Ti_{8.6}Nb_{0.5}Cu_{2.6} alloy. This alloy also has about 14% less Co as compared to commercial sintered ARNOLD grade 8H Alnico alloy.

In this Example 5a, the Fe_{29.9}Co_{29.2}Ni_{14.6}Al_{14.6}Ti_{8.6}Nb_{0.5}Cu_{2.6} alloy pursuant to the invention was arc-melted and cast in a shaped cavity of a water-cooled copper hearth, where the specimen was cooled radially to room temperature. Then, the small cylinders with outer diameter of about 3 millimeters length of about 8 millimeters were cut ready for tests.

The optimization of the magnetic properties of the anisotropic cast alloy pursuant to the invention was achieved by lower temperature solutionizing heat treatment at 1165 degrees C. for 20 minutes with subsequent oil quenching. Similar to the commercial sintered ARNOLD grade 8H Alnico alloy, the crystallographically anisotropic alloy pursuant to the invention clearly showed predominant formation of high temperature α-phase (B2) that transformed during spinodal reaction into fine and uniform trace of crystallographically coherent α1(B2′)/α2(L2₁) phase components as determined by SEM (scanning electron microscope) and XRD (X-ray diffraction) analyses.

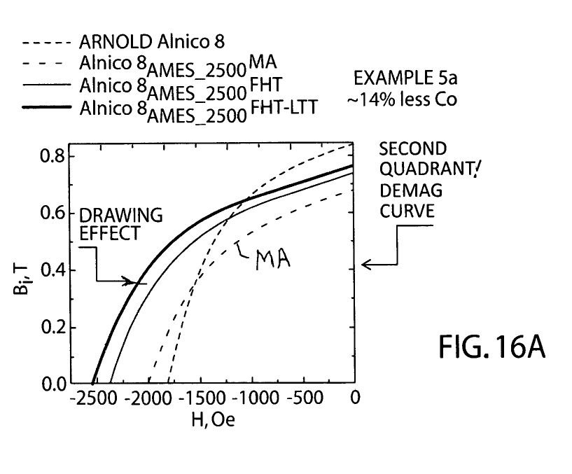

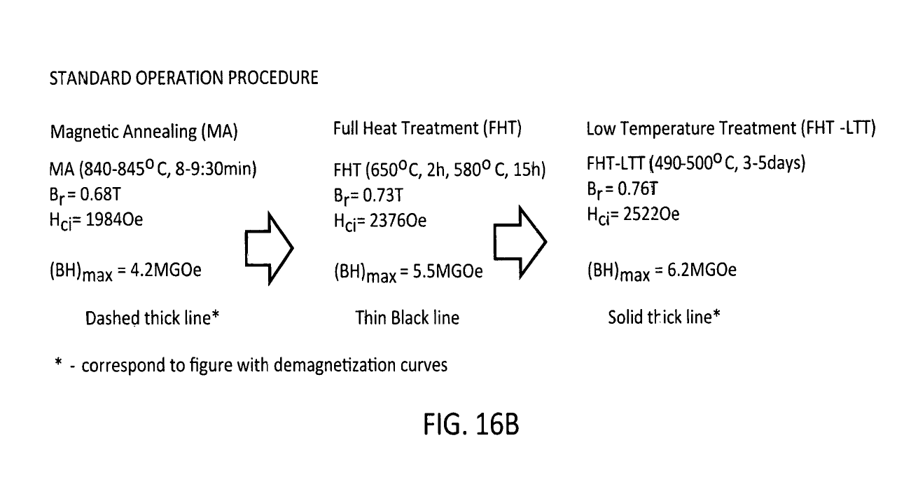

The alloy specimens then were subjected to the heat treatments shown in FIG. 16B. FIG. 16A illustrates the effect of the heat treatments of FIG. 16B on the second quadrant/demagnetization curves (from the B-H loops) of the oil quenched alloy pursuant to the invention described.

FIG. 16A reveals that the MA-treated alloy sample (dashed line labelled MA) exhibited a (BH)ₘₐₓ=4.2 MGOe; that the FHT-treated alloy sample (thin solid black line) exhibited an energy product (BH)ₘₐₓ=5.5 MGOe; and that the FHT-LTT alloy sample (thick solid black line) exhibited a (BH)ₘₐₓ=6.2 MGOc.

FIG. 16A also reveals that the MA-treated alloy sample exhibited an intrinsic coercive force H_{ci.}=1984 Oe; that the FHT-treated alloy sample exhibited an H_{ci.}=2376 Oe; and that the FHT-LTT alloy sample exhibited an H_{ci.}=2522 Oe.

FIG. 16A further shows that magnetic coercivity of Example 5a significantly surpasses typical values of ARNOLD Alnico 8 (closely spaced dashed line) as well as all known commercial Alnico grades (Table 1).

The present invention thus provides an Alnico alloy that is leaner (i.e., lower in Co content) and yet retains at least substantially the same or much better magnetic properties as the corresponding more costly, commercially available Alnico alloy with high Co content. For example, the Co-lean Alnico alloys pursuant to embodiments of the invention derived from Alnico grades with high Co contents, such as grades 8 and 9 having about 31.5 atomic % or more Co, are beneficial in order to save significant material costs.

While the invention has been described in terms of specific embodiments thereof, it is not intended to be limited there to but rather only to the extent set forth in the following claims.

We claim:

1. A Co-lean Alnico alloy having a composition, in atomic %, comprising about 15% to 31% Co, about 14% to about 19% Al, about 14% to about 22% Ni, about 0.5% to about 4.0% Cu, about 6% to about 9% Ti, and about 29% to about 40% Fe.

2. The alloy of claim 1 including one or more of Nb, Si, Ge and S in quantities in the range of 0.2 to 1.0 atomic %.

3. The alloy of claim 2 wherein a Nb content is present in an amount of about 0.4 to about 0.8 atomic %.

4. The alloy of claim 1 that is heat treated using a solution treatment followed by magnetic annealing and then multiple low temperature heat treatments.

5. The heat treated alloy of claim 4 having an intrinsic coercive force H_{ci} of at least allow 2000 Oe.

6. The heat treated alloy of claim 5 having an intrinsic coercive force H_{ci} of at least about 2400 Oe. and an energy product (BH)ₘₐₓ of least about 6 MGOe.

7. The alloy of claim 1 wherein the Co content does not exceed about 30 atomic %.

8. The alloy of claim 1 having a Ti content of about 8.6 to 8.8 atomic %.

9. The alloy of claim 1 having a Cu content of about 2.5 to 2.6 atomic %.

10. The alloy of claim 1 having a composition comprising, in atomic %, of about 10% to about 24% Co, about 14% to about 19% Al, about 18% to about 25% Ni, about 0.5% to about 4.0% Cu, about 6% to about 9% Ti, and about 29% to about 41% Fe.

11. A Co-lean Alnico alloy having a composition, in atomic %, comprising about 15% to 31% Co, about 14% to about 22% Al, about 14% to about 22% Ni, about 0.5% to about 4.0% Cu, about 6% to about 8.5% Ti, and about 32% to about 40% Fe.

12. The alloy of claim 11 wherein the Co content does not exceed 30 atomic %.

13. The alloy of claim 11 that further includes an amount of Nb, Si, Ge and/or S in individual quantities in the range of 0.2 to 1.0 atomic %.

14. The alloy of claim 13 that further includes an amount of N b in the range of 0.4 to 0.8 atomic %.

15. A method of making a magnetic material, comprising subjecting a Co-lean Alnico alloy having a composition, in atomic %, of about 15% to 31% Co, about 14% to about 19% Al, about 14% to about 22% Ni, about 0.5% to about 4.0% Cu, about 6% to about 9% Ti, and about 29% to about 40% Fe to a solution treatment followed by magnetic annealing and then multiple low temperature treatments wherein a last low temperature treatment is conducted at about 490 to about 500° C. for about 3 to about 5 days.

16. The method of claim 15 wherein the solution treatment is conducted at about 1160 to about 1170° C.

17. The method of claim 15 wherein the magnetic annealing is conducted at about 640 to about 660° C. for about 7 to about 10 minutes.

18. The method of claim 15 wherein a first low temperature treatment is conducted at about 640 to about 660° C. for about 14 to about 1.5 to about 2.5 hours.

19. The method of claim 15 wherein a second low temperature treatment is conducted at about 570 to about 590° C. for about 14 to about 16 hours.

20. The method of claim 19 wherein a third low temperature treatment is said last low temperature treatment.
